(19) United States
(12) Patent Application Publication
(10) Pub. No.: US 2024/0330798 A1
(43) Pub. Date: Oct. 3, 2024

(54) System and Method of Forecasting Individual Task Durations

(71) Applicant: Blue Yonder Group, Inc., Scottsdale, AZ (US)

(72) Inventors: Taashi Kapoor, Brookfield, WI (US); Steven Paul Cheney, Waukesha, WI (US); Venkat Korthiwada, Farmers Branch, TX (US)

(21) Appl. No.: 18/526,807

(22) Filed: Dec. 1, 2023

Related U.S. Application Data
(60) Provisional application No. 63/455,514, filed on Mar. 29, 2023.
(60) Provisional application No. 63/458,844, filed on Apr. 12, 2023.

(51) Int. Cl. G06Q 10/0631; G06Q 10/0639

(52) U.S. Cl. CPC G06Q 10/063114; G06Q 10/06393

(57) ABSTRACT

A system and method are disclosed for determining machine learning model retraining. The method comprises merging predicted task time durations and task history data, where the predicted task time durations are based on a machine learning model, calculating a duration for each of the completed tasks, calculating error metrics based on the duration of each of the completed tasks and a corresponding predicted task time duration for each of the completed tasks, averaging the error metrics over a period of time and storing the averaged error metrics as error metric data, determining whether the averaged error metrics exceed a threshold, in response to determining that the threshold has not been exceeded, continuing use of the machine learning model to predict task time durations, and in response to determining that the threshold has been exceeded, retraining the machine learning model via a model training loop.

### CROSS-REFERENCE TO RELATED APPLICATIONS

The present disclosure is related to that disclosed in the U.S. Provisional Application No. 63/455,514, filed Mar. 29, 2023, entitled “Forecasted Individual Task Durations and Variations for Logistics,” and U.S. Provisional Application No. 63/458,844, filed Apr. 12, 2023, entitled “Forecasting Individual Task Durations while Accounting for Task Variations.” U.S. Provisional Application Nos. 63/455,514 and 63/458,844 are assigned to the assignee of the present application. The present invention hereby claims priority under 35 U.S.C. § 119(e) to U.S. Provisional Application Nos. 63/455,514 and 63/458,844.

### TECHNICAL FIELD

The present disclosure relates generally to supply chain logistics, and more specifically to forecasting individual task durations.

### BACKGROUND

Goal times are projected times to complete a task by a resource, such as a human worker or a robot, which allows for the planning and scheduling of resource capacity. Existing systems generally use static goals times, that is, a time value set based only on the type of task to be performed. Such approaches, however, do not account for other factors that create significant variations in task duration. For example, the duration of a warehouse picking task heavily depends on the location in the warehouse of the item to pick. As another example, a task may take less time to complete at a certain time of day, such as a time closer to a lunch break or the end of the workday. Such variations cause significant deviations between goal times and actual durations of tasks, increasing the error over time and affecting the planning of future tasks. Existing systems are thus unable to accurately account for such deviations, which decreases efficiency of scheduling and consuming resource capacity and increases operating costs, all of which are undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates a supply chain network, in accordance with a first embodiment;

FIG. 2 illustrates the task time forecasting system, the archiving system, and the planning and execution system of FIG. 1 in greater detail, in accordance with an embodiment;

FIG. 3 illustrates a diagram of variations in task times in a warehouse, in accordance with an embodiment;

FIG. 4 illustrates a method for training a machine learning model to predict task times, in accordance with an embodiment;

FIG. 5 illustrates a method for predicting task times using a machine learning model, in accordance with an embodiment;

FIG. 6 illustrates a method for determining machine learning model retraining, in accordance with an embodiment;

FIGS. 7A-7C illustrate predicted goal time graphs, in accordance with an embodiment;

FIG. 8 illustrates box plots for task time prediction methods, in accordance with an embodiment;

FIG. 9 illustrates an output of a task time forecasting system, such as the task time forecasting system of FIG. 1, in accordance with an embodiment; and

FIG. 10 illustrates a feature impact graph, in accordance with an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

As described below, embodiments of the following disclosure provide systems and methods of a training machine learning (ML) model using comprehensive task information for warehouse tasks, including a type of task, source and destination locations, start and end times, a device code, a manual (or static) goal time, priority, and/or a comfort buffer. Embodiments may receive a report of all planned tasks at a warehouse and, using the machine learning model trained on the task history data, predict task times for the planned tasks. Embodiments produce predictions trained on comprehensive task information to dynamically change predicted durations of tasks. Embodiments provide the ability to examine what factors influence the time it takes to complete a task and to what extent the factors influence the time.

Embodiments of the following disclosure enable systems and methods that enable supply chain or warehouse operators to handle the significant deviations that occur in existing task time predictions when compared to actual task durations. Use of embodiments allows for supply chain planning that schedules and consumes resource capacity more efficiently. Use of embodiments may also enable the determination of more accurate task priorities as well as the automatic and dynamic prediction and adjustment of task goal times. Use of embodiments may further optimize the planning of future tasks and reduce operating costs at warehouses or other supply chain entities.

Although, for the sake of clearness, the description below primarily describes embodiments predicting task times in the context of warehouses or distribution centers, embodiments contemplate the application of the approaches discussed herein to any supply chain entity, including, but not limited to, manufacturing facilities, suppliers, retailers, and/or any other entities that estimate the time required to complete one or more tasks.

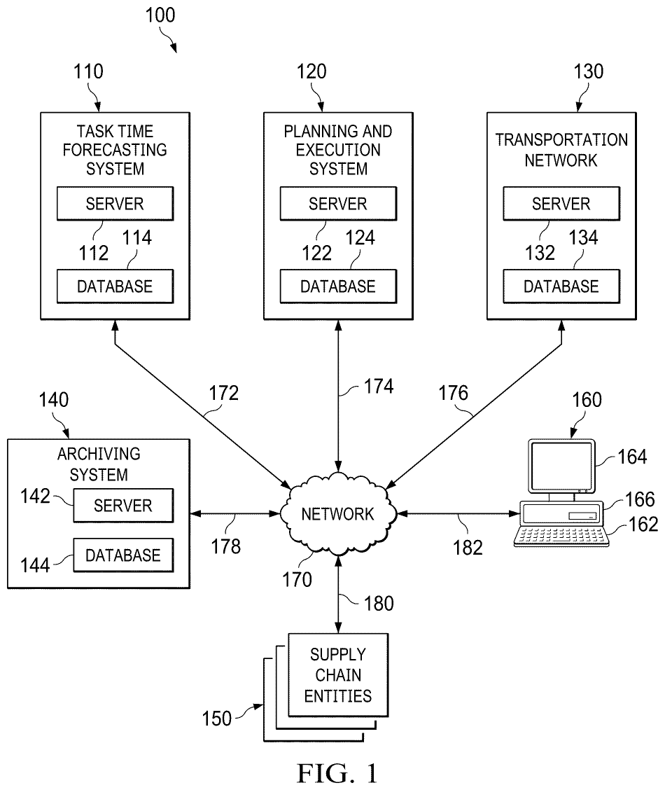

FIG. 1 illustrates supply chain network 100, in accordance with a first embodiment. Supply chain network 100 comprises task time forecasting system 110, planning and execution system 120, transportation network 130, archiving system 140, one or more supply chain entities 150, one or more computers 160, network 170, and one or more communication links 172-182. Although a single task time forecasting system 110, a single planning and execution system 120, a single transportation network 130, a single archiving system 140, one or more supply chain entities 150, one or more computers 160, a single network 170, and one or more communication links 172-182 are shown and described, embodiments contemplate any number of task time forecasting systems, planning and execution systems, transportation networks, archiving systems, supply chain entities, computers, networks, or communication links according to particular needs.

In one embodiment, task time forecasting system 110 comprises server 112 and database 114. Although task time forecasting system 110 is illustrated in FIG. 1 as comprising a single server 112 and a single database 114, embodiments contemplate task time forecasting system 110 including any suitable number of servers or databases, serverless computing options, or data stores, internal to, or externally coupled with, task time forecasting system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. As explained in more detail below, task time forecasting system 110 trains one or more machine learning models to predict task times for a set of tasks, and uses the trained machine learning models to predict task times for a set of future scheduled tasks. In embodiments, task time forecasting system 110 may retrain the one or more machine learning models based, at least in part, on an error metric threshold. Task time forecasting system 110 may receive historical data and/or current data from planning and execution system 120, transportation network 130, archiving system 140, one or more supply chain entities 150, and/or one or more computers 160 of supply chain network 100.

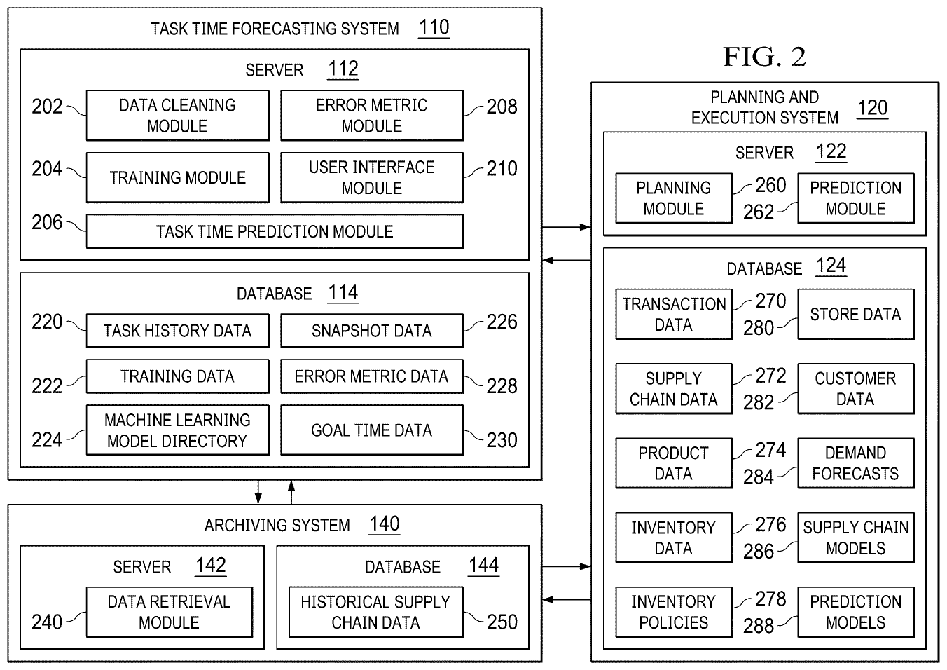

According to an embodiment, planning and execution system 120 comprises server 122 and database 124. Supply chain planning and execution is typically performed by several distinct and dissimilar processes, including, for example, assortment planning, demand planning, operations planning, production planning, supply planning, distribution planning, execution, pricing, forecasting, transportation management, warehouse management, inventory management, fulfilment, procurement, and the like. Server 122 of planning and execution system 120 comprises one or more modules, such as, for example, planning module 260 (FIG. 2), a solver, a modeler, and/or an engine, for performing actions of one or more planning and execution processes. Server 122 stores and retrieves data from database 124 or from one or more locations in supply chain network 100. In addition, planning and execution system 120 operates on one or more computers 160 that are integral to, or separate from, the hardware and/or software that support transportation network 130, archiving system 140, and one or more supply chain entities 150. In an embodiment, server 122 of planning and execution system 120 is configured to receive and transmit item data, including item identifiers, pricing data, attribute data, inventory levels, and other like data about one or more items at one or more locations in supply chain network 100. Server 122 stores and retrieves item data from database 124 or one or more locations in supply chain network 100.

By way of example only and not by way of limitation, planning and execution system 120 comprises a warehouse management system. According to embodiments, server 122 of planning and execution system 120 comprising the warehouse management system comprises one or more modules that manage and operate warehouse operations, plan timing and identity of shipments, and generate picklists, packing plans, and instructions. The warehouse management system instructs users and/or automated machinery to obtain picked items and generates instructions to guide placement of items on a picklist in the configuration and layout determined by a packing plan. For example, the instructions may instruct a user and/or automated machinery to prepare items on a picklist for shipment by obtaining the items from inventory or a staging area and packing the items on a pallet in a proper configuration for shipment. Embodiments contemplate the warehouse management system determining routing, packing, or placement of any item, package, or container into any packing area, including, packing any item, package, or container in another item, package, or container. The warehouse management system may generate instructions for packing products into boxes, packing boxes onto pallets, packing loaded pallets into trucks, or placing any item, container, or package in a packing area, such as, for example, a box, a pallet, a shipping container, a transportation vehicle, a shelf, a designated location in a warehouse (such as a staging area), and the like.

Transportation network 130 comprises server 132 and database 134. According to embodiments, transportation network 130 directs one or more transportation vehicles to ship one or more items from one or more stocking locations of one or more supply chain entities 150. In embodiments, the one or more transportation vehicles may comprise a truck fleet used for performing deliveries. In addition, the number of items shipped by the one or more transportation vehicles in transportation network 130 may also be based, at least in part, on the number of items currently in stock at one or more stocking locations of one or more supply chain entities 150, the number of items currently in transit, a forecasted demand, a supply chain disruption, and the like. The one or more transportation vehicles comprise, for example, any number of trucks, cars, vans, boats, airplanes, unmanned aerial vehicles (UAVs), cranes, robotic machinery, or the like. According to embodiments, one or more transportation vehicles may be associated with one or more supply chain entities 150 and may be directed by automated navigation including, for example, GPS guidance, according to particular needs. The one or more transportation vehicles may be used to perform crossdocking at a supply chain entity, meaning one or more shipments are taken from a first transportation vehicle and placed on a second transportation vehicle without first being stored in a storage area, such as a warehouse, distribution center, or retail location.

Archiving system 140 of supply chain network 100 comprises server 142 and database 144. Although archiving system 140 is shown as comprising a single server 142 and a single database 144, embodiments contemplate any suitable number of servers or databases internal to, or externally coupled with, archiving system 140. Server 142 of archiving system 140 may support one or more processes for receiving and storing data from planning and execution system 120, transportation network 130, one or more supply chain entities 150, and/or one or more computers 160 of supply chain network 100, as described in more detail herein. According to some embodiments, archiving system 140 comprises an archive of data received from planning and execution system 120, transportation network 130, one or more supply chain entities 150, and/or one or more computers 160 of supply chain network 100. Archiving system 140 provides archived data to task time forecasting system 110 and/or planning and execution system 120 to, for example, train one or more machine learning models. Server 142 may store the received data in database 144. Database 144 of archiving system 140 may comprise one or more databases or other data storage arrangements at one or more locations, local to, or remote from, server 142.

One or more supply chain entities 150 may include, for example, one or more retailers, distribution centers, manufacturers, suppliers, customers, and/or similar business entities configured to manufacture, order, transport, or sell one or more products. Retailers may comprise any online or brick-and-mortar store that sells one or more products to one or more customers. Retailers may have one or more resources, such as, for example, humans, machines, robots, or the like. Manufacturers may be any suitable entity that manufactures at least one product, which may be sold by one or more retailers. Suppliers may be any suitable entity that offers to sell or otherwise provides one or more items (i.e., materials, components, or products) to one or more manufacturers. Although one example of supply chain network 100 is illustrated and described, embodiments contemplate any configuration of supply chain network 100, without departing from the scope described herein.

As shown in FIG. 1, supply chain network 100 comprising task time forecasting system 110, planning and execution system 120, transportation network 130, archiving system 140, and one or more supply chain entities 150 may operate on one or more computers 160 that are integral to, or separate from, the hardware and/or software that support task time forecasting system 110, planning and execution system 120, transportation network 130, archiving system 140, and one or more supply chain entities 150. One or more computers 160 may include any suitable input device 162, such as a keypad, mouse, touch screen, microphone, or other device to input information. Output device 164 may convey information associated with the operation of supply chain network 100, including digital or analog data, visual information, or audio information. One or more computers 160 may include fixed or removable computer-readable storage media, including a non-transitory computer readable medium, magnetic computer disks, flash drives, CD-ROM, in-memory device, or other suitable media to receive output from and provide input to supply chain network 100.

One or more computers 160 may include one or more processors 166 and associated memory to execute instructions and manipulate information according to the operation of supply chain network 100 and any of the methods described herein. In addition, or as an alternative, embodiments contemplate executing the instructions on one or more computers 160 that cause one or more computers 160 to perform functions of the methods. An apparatus implementing special purpose logic circuitry, for example, one or more field programmable gate arrays (FPGA) or application-specific integrated circuits (ASIC), may perform functions of the methods described herein. Further examples may also include articles of manufacture including tangible non-transitory computer-readable media that have computer-readable instructions encoded thereon, and the instructions may comprise instructions to perform functions of the methods described herein.

In addition, or as an alternative, supply chain network 100 may comprise a cloud-based computing system, including but not limited to serverless cloud computing, having processing and storage devices at one or more locations, local to, or remote from, task time forecasting system 110, planning and execution system 120, transportation network 130, archiving system 140, and one or more supply chain entities 150. In addition, each of the one or more computers 160 may be a workstation, personal computer (PC), network computer, notebook computer, tablet, personal digital assistant (PDA), cell phone, telephone, smartphone, wireless data port, augmented or virtual reality headset, or any other suitable computing device. In an embodiment, one or more users may be associated with task time forecasting system 110 and archiving system 140. These one or more users may include, for example, an “administrator” handling machine learning model training, administration of cloud computing systems, and/or one or more related tasks within supply chain network 100. In the same or another embodiment, one or more users may be associated with planning and execution system 120, transportation network 130, and/or one or more supply chain entities 150.

In one embodiment, task time forecasting system 110 may be coupled with network 170 using communication link 172, which may be any wireline, wireless, or other link suitable to support data communications between task time forecasting system 110 and network 170 during operation of supply chain network 100. Planning and execution system 120 may be coupled with network 170 using communication link 174, which may be any wireline, wireless, or other link suitable to support data communications between planning and execution system 120 and network 170 during operation of supply chain network 100. Transportation network 130 may be coupled with network 170 using communication link 176, which may be any wireline, wireless, or other link suitable to support data communications between transportation network 130 and network 170 during operation of supply chain network 100. Archiving system 140 may be coupled with network 170 using communication link 178, which may be any wireline, wireless, or other link suitable to support data communications between archiving system 140 and network 170 during operation of supply chain network 100. One or more supply chain entities 150 may be coupled with network 170 using communication link 180, which may be any wireline, wireless, or other link suitable to support data communications between one or more supply chain entities 150 and network 170 during operation of supply chain network 100. One or more computers 160 may be coupled with network 170 using communication link 182, which may be any wireline, wireless, or other link suitable to support data communications between one or more computers 160 and network 170 during operation of supply chain network 100. Although communication links 172-182 are shown as generally coupling task time forecasting system 110, planning and execution system 120, transportation network 130, archiving system 140, one or more supply chain entities 150, and one or more computers 160 to network 170, any of task time forecasting system 110, planning and execution system 120, transportation network 130, archiving system 140, one or more supply chain entities 150, and one or more computers 160 may communicate directly with each other, according to particular needs.

In another embodiment, network 170 includes the Internet and any appropriate local area networks (LANs), metropolitan area networks (MANs), or wide area networks (WANs) coupling task time forecasting system 110, planning and execution system 120, transportation network 130, archiving system 140, one or more supply chain entities 150, and one or more computers 160. For example, data may be maintained locally to, or externally of, task time forecasting system 110, planning and execution system 120, transportation network 130, archiving system 140, one or more supply chain entities 150, and one or more computers 160 and made available to one or more associated users of task time forecasting system 110, planning and execution system 120, transportation network 130, archiving system 140, one or more supply chain entities 150, and one or more computers 160 using network 170 or in any other appropriate manner. For example, data may be maintained in a cloud database at one or more locations external to task time forecasting system 110, planning and execution system 120, transportation network 130, archiving system 140, one or more supply chain entities 150, and one or more computers 160 and made available to one or more associated users of task time forecasting system 110, planning and execution system 120, transportation network 130, archiving system 140, one or more supply chain entities 150, and one or more computers 160 using the cloud or in any other appropriate manner. Those skilled in the art will recognize that the complete structure and operation of network 170 and other components within supply chain network 100 are not depicted or described. Embodiments may be employed in conjunction with known communications networks and other components.

FIG. 2 illustrates task time forecasting system 110, archiving system 140, and planning and execution system 120 of FIG. 1 in greater detail, in accordance with an embodiment. Task time forecasting system 110 may comprise server 112 and database 114, as described above. Although task time forecasting system 110 is shown as comprising a single server 112 and a single database 114, embodiments contemplate task time forecasting system 110 comprising any suitable number of servers or databases, serverless computing options, or data stores, internal to, or externally coupled with, task time forecasting system 110, according to particular needs.

Server 112 of task time forecasting system 110 comprises data cleaning module 202, training module 204, task time prediction module 206, error metric module 208, and user interface module 210. Although server 112 is shown and described as comprising a single data cleaning module 202, a single training module 204, a single task time prediction module 206, a single error metric module 208, and a single user interface module 210, embodiments contemplate any suitable number or combination of these located at one or more locations, local to, or remote from, task time forecasting system 110, such as on multiple servers or computers 160 at one or more locations in supply chain network 100. Embodiments of task time forecasting system 110 may utilize serverless computing options to execute the processes of data cleaning module 202, training module 204, task time prediction module 206, error metric module 208, and user interface module 210.

In one embodiment, data cleaning module 202 of task time forecasting system 110 receives data from planning and execution system 120, transportation network 130, archiving system 140, one or more supply chain entities 150, one or more computers 160, or one or more data storage locations local to, or remote from, supply chain network 100 and task time forecasting system 110, and prepares the data for use in training the one or more machine learning models. For example, data cleaning module 202 may obtain warehouse task data from a warehouse management system or a warehouse execution system, such as task history data 220 or snapshot data 226. Data cleaning module 202 prepares received data for use in training and prediction by checking received data for errors and transforming the received data. Data cleaning module 202 may check received data for errors in the range, sign, and/or value and use statistical analysis to check the quality or the correctness of the data, and otherwise filter and clean the received data for use in training one or more machine learning models. According to embodiments, data cleaning module 202 may globally filter outliers in received data using thresholds, such as an upper and lower bound. For example, data cleaning module 202 may determine an upper and lower bound to filter task history data 220 based on a factor or percentage of the goal time of a task, such as 3.5 times the goal time of the task. As another example, data cleaning module 202 may filter task history data 220 based on a minimum task duration, such as removing data of tasks with recorded task times that are so short that the entry is likely an error (e.g., an entered task time of less than two seconds).

In embodiments, data cleaning module 202 may remove noise from received data resulting from inaccurate manual data entry. For example, data cleaning module 202 may base a lower threshold for a task, based, at least in part, on a factor or percentage of a calculated interquartile range, and replace recorded task times that exceed the threshold with an average duration for the task type of the task corresponding to tasks that have approximately the same source work zone and destination work zone. Data cleaning module 202 may further impute missing data and generate new features based on the received data, such as new data columns or other data arrangements. For example, when the number of items in a pick list is missing for a list pick task in a warehouse, data cleaning module 202 may calculate the average value for all tasks in the same warehouse and task type that have similar characteristics, such as destination location, source location, time period, and the like, and replace the missing value with the calculated value. In addition, or as an alternative, data cleaning module 202 may transform the received data to normalize, aggregate, and/or rescale the data to allow direct comparison of received data from planning and execution system 120. For example, data cleaning module 202 may transform snapshot data 226 to allow direct comparison to task history data 220. Data cleaning module 202 may store the received and/or transformed data as training data 222.

Training module 204 uses filtered and cleaned training data 222 to train one or more machine learning models by (1) identifying correlated factors, relevant attributes, and/or relevant historical data in training data 222, and (2) using the one or more identified correlated factors, relevant attributes, and/or relevant historical data to train one or more machine learning models to predict task times associated with one or more tasks. In some embodiments, training module 204 may use approximately 85% of available data as training data 222, while retaining the remaining approximately 15% of available data as validation data to ensure the one or more machine learning models are accurately predicting task times. In embodiments, training module 204 may train or retrain the one or more machine learning models based on an error metric threshold, as described in greater detail below.

According to embodiments, training module 204 may train decision tree models (such as, for example, a random forest model) or one or more other machine learning models according to particular needs. Training module 204 may access training data 222 and use a machine learning method to train the machine learning models. Training module 204 may use a machine learning method to identify, according to embodiments, any correlated factors, relevant attributes, and/or relevant historical data in training data 222, and/or other model features for the one or more machine learning models. By way of example only and not by way of limitation, when training module 204 trains a machine learning model to predict task times for a warehouse, training module 204 may identify the following relevant features in training data 222: a manually-set goal time for the task, a number of units completed, a device used to complete the task, a source location of the task, a starting hour of the task, a destination work zone of the task, a destination location of the task, an input priority of the task, an optimized priority of the task, a completed priority of the task, a start day of the week for the task, a source work zone of the task, an output priority of the task, a task type of the task, an applied goal time of the task, a comfort buffer for the task, a unit of measure for the task, whether the task is late, and/or any other relevant features. In embodiments, training module 204 may train or retrain the one or more machine learning models in a cycle that is asynchronous from the prediction cycle. That is, a previous model may continue predicting task times while a new model is training or when a model is retraining. Training module 204 stores the one or more trained machine learning models in machine learning model directory 224.

Task time prediction module 206 accesses the one or more machine learning models of machine learning model directory 224 and snapshot data 226 corresponding to a set of tasks, and applies snapshot data 226 to the one or more machine learning models to generate task time predictions for the set of tasks. In an embodiment, task time prediction module 206 may use the one or more machine learning models to simulate multiple scenario outcomes for one or more tasks. For example, task time prediction module 206 may simulate a particular scenario one hundred times, 1,000 times, 10,000 times, or any other number of times to generate a predicted task time associated with a particular task. In embodiments, task time prediction module 206 may store the predicted task times as goal time data 230.

Error metric module 208 calculates one or more error metrics corresponding to each predicted task time. In embodiments, error metric module 208 may calculate mean absolute error (MAE), root mean square error (RMSE), and mean average percentage error (MAPE), among one or more other error metrics, based on predicted task time durations and actual task time durations for a task. Error metric module 208 averages the calculated error metric values for a supply chain entity of one or more supply chain entities 150 over a time period such as, for example, an hour, a day, a week, or the like. When the average error metric values exceed a threshold, which in embodiments may be set via user interface module 210, training module 204 may retrain the one or more machine learning models, as described in greater detail below.

User interface module 210 of task time forecasting system 110 generates and displays a user interface (UI), such as, for example, a graphical user interface (GUI), that displays one or more task time predictions, goal times, task history data 220, training data 222, machine learning model directory 224, snapshot data 226, and/or error metric data 228. According to embodiments, user interface module 210 displays a GUI comprising interactive graphical elements for selecting one or more warehouses, task time predictions, and/or data of any kind stored in database 114 of task time forecasting system 110 and displaying the selected data on one or more display devices in response to the selection. According to embodiments, the data from the UI may also be displayed in other UIs from any other systems or modules throughout supply chain network 100, such as, for example, a warehouse module, or any integration.

Database 114 of task time forecasting system 110 may comprise one or more databases, data stores, or other data storage arrangements at one or more locations, local to, or remote from, server 112. Database 114 of task time forecasting system 110 comprises, for example, task history data 220, training data 222, machine learning model directory 224, snapshot data 226, error metric data 228, and goal time data 230. Although database 114 of task time forecasting system 110 is shown and described as comprising task history data 220, training data 222, machine learning model directory 224, snapshot data 226, error metric data 228, and goal time data 230, embodiments contemplate any suitable number or combination of these, located at one or more locations, local to, or remote from, task time forecasting system 110 according to particular needs.

Task history data 220 comprises information related to completed tasks within supply chain network 100, such as all completed tasks for a particular warehouse over a particular time period. In the example of a warehouse, possible tasks may include picks, transfers, storage, replenishment, variations thereof, or any other activity that may be assigned for completion in a warehouse. In embodiments, task time forecasting system 110 may receive task history data 220 in real time as tasks are completed from, for example, the warehouse management system of planning and execution system 120 or one or more other locations in supply chain network 100. Task history data 220 may comprise task start times, task completion times, task durations, and the like associated with tasks, as well as other metadata such as task start and end locations, time of day of task performance, and various other task attributes as described above.

Training data 222 comprises a selection of one or more periods of historical supply chain data 250 prepared by data cleaning module 202 at various levels of granularity and presented to training module 204 to train one or more machine learning models. According to one embodiment, training data 222 comprises task history data 220, as described in greater detail above, such as task metadata, warehouse activity schedules, task logs, and/or other factors. As described above, task time forecasting system 110 may receive training data 222 from planning and execution system 120, transportation network 130, archiving system 140, one or more supply chain entities 150, one or more computers 160, or one or more data storage locations local to, or remote from, supply chain network 100 and task time forecasting system 110. In an embodiment, training data 222 may be cleaned, filtered, and/or otherwise processed by data cleaning module 202 to prepare training data 222 for use in training the one or more machine learning models. In embodiments, training module 204 may use only a certain portion of training data 222 for training and use the remaining portion of training data 222 as validation data for the one or more machine learning models.

Machine learning model directory 224 comprises one or more machine learning models trained by training module 204 to predict task times associated with future scheduled tasks for a warehouse and/or any other supply chain entity of one or more supply chain entities 150. Machine learning models directory 224 may further comprise all previously trained machine learning models, which may be accessed via user interface module 210. According to embodiments, the one or more machine learning models may be based on decision tree machine learning algorithms, such as, for example, a random forest algorithm.

Snapshot data 226 comprises all tasks scheduled for future completion at one or more supply chain entities 150. In the example of a warehouse, snapshot data 226 may include a set of warehouse tasks scheduled for a day, such as all picks and other warehouse tasks that are to be completed by the end of the day. Snapshot data further 226 comprises metadata, including the same types of metadata associated with task history data 220, such as, for example, the time that the tasks are scheduled to begin and any other relevant task features, as discussed in greater detail below.

Error metric data 228 comprises error metric values generated by error metric module 208 corresponding to the task time predictions. Error metric data 228 may further comprise average error metric values over a period of time, as well as a threshold error metric value that causes training module 204 to retrain a machine learning model when exceeded. For example, when a threshold for the MAE error metric is set at twenty and error metric module 208 calculates the average MAE value over a period of two days as twenty-five for predictions generated by a particular machine learning model, training module 204 retrains the particular machine learning model.

Goal time data 230 comprises predicted task times generated by the one or more machine learning models. According to embodiments, error metric module 208 may use goal time data 230 to calculate the one or more error metrics corresponding to each predicted task time. Goal time data 230, as discussed in greater detail below, may be significantly more accurate than estimates of task times used in existing supply chain networks.

As discussed above, archiving system 140 comprises server 142 and database 144. Although archiving system 140 is shown as comprising a single server 142 and a single database 144, embodiments contemplate any suitable number of servers or databases internal to, or externally coupled with, archiving system 140.

Server 142 of archiving system 140 comprises data retrieval module 240. Although server 142 is shown and described as comprising a single data retrieval module 240, embodiments contemplate any suitable number or combination of data retrieval modules located at one or more locations, local to, or remote from archiving system 140, such as on multiple servers or computers 160 at one or more locations in supply chain network 100.

In one embodiment, data retrieval module 240 of archiving system 140 receives historical supply chain data 250 from planning and execution system 120 and one or more supply chain entities 150, and stores received historical supply chain data 250 in archiving system 140 database 144. According to one embodiment, data retrieval module 240 of archiving system 140 may prepare historical supply chain data 250 for use as training data 222 of task time forecasting system 110 by checking historical supply chain data 250 for errors and transforming historical supply chain data 250 to normalize, aggregate, and/or rescale historical supply chain data 250 to allow direct comparison of data received from different planning and execution systems 120, one or more supply chain entities 150, and/or one or more other locations local to, or remote from, archiving system 140. According to embodiments, data retrieval module 240 may receive data from one or more sources external to supply chain network 100, such as, for example, weather data, special events data, social media data, calendar data, and the like and stores the received data as historical supply chain data 250.

Database 144 of archiving system 140 may comprise one or more databases or other data storage arrangements at one or more locations, local to, or remote from, server 142. Database 144 of archiving system 140 comprises, for example, historical supply chain data 250. Although database 144 of archiving system 140 is shown and described as comprising historical supply chain data 250, embodiments contemplate any suitable number or combination of data, located at one or more locations, local to, or remote from, archiving system 140, according to particular needs.

Historical supply chain data 250 comprises historical data received from task time forecasting system 110, planning and execution system 120, transportation network 130, archiving system 140, one or more supply chain entities 150, and/or one or more computers 160. Historical supply chain data 250 may comprise, for example, weather data, special events data, social media data, calendar data, and the like. In an embodiment, historical supply chain data 250 may comprise, for example, historic sales patterns, prices, promotions, weather conditions, and other factors influencing future demand of the number of one or more items sold in one or more stores over a time period, such as, for example, one or more days, weeks, months, years, including, for example, a day of the week, a day of the month, a day of the year, week of the month, week of the year, month of the year, special events, paydays, and the like.

As discussed above, planning and execution system 120 comprises server 122 and database 124. Although planning and execution system 120 is shown as comprising a single server 122 and a single database 124, embodiments contemplate any suitable number of servers or databases internal to, or externally coupled with, planning and execution system 120.

Server 122 of planning and execution system 120 comprises planning module 260 and prediction module 262. Although server 122 is shown and described as comprising a single planning module 260 and a single prediction module 262, embodiments contemplate any suitable number or combination of planning modules and prediction modules located at one or more locations, local to, or remote from, planning and execution system 120, such as on multiple servers or computers 160 at one or more locations in supply chain network 100.

Database 124 of planning and execution system 120 may comprise one or more databases or other data storage arrangements at one or more locations, local to, or remote from, server 122. Database 124 of planning and execution system 120 comprises, for example, transaction data 270, supply chain data 272, product data 274, inventory data 276, inventory policies 278, store data 280, customer data 282, demand forecasts 284, supply chain models 286, and prediction models 288. Although database 124 of planning and execution system 120 is shown and described as comprising transaction data 270, supply chain data 272, product data 274, inventory data 276, inventory policies 278, store data 280, customer data 282, demand forecasts 284, supply chain models 286, and prediction models 288, embodiments contemplate any suitable number or combination of data, located at one or more locations, local to, or remote from, planning and execution system 120, according to particular needs.

Planning module 260 of planning and execution system 120 works in connection with prediction module 262 to generate a plan based on one or more predicted retail volumes, classifications, or other predictions. By way of example and not of limitation, planning module 260 may comprise a demand planner that generates a demand forecast for one or more supply chain entities 150. Planning module 260 may generate the demand forecast, at least in part, from predictions and calculated factor values for one or more causal factors received from prediction module 262. By way of a further example, planning module 260 may comprise an assortment planner and/or a segmentation planner that generates product assortments that match causal effects calculated for one or more customers or products by prediction module 262, which may provide for increased customer satisfaction and sales, as well as reduce costs for shipping and stocking products at stores where they are unlikely to sell.

Prediction module 262 of planning and execution system 120 applies samples of transaction data 270, supply chain data 272, product data 274, inventory data 276, store data 280, customer data 282, demand forecasts 284, and other data to prediction models 288 to generate predictions and calculated factor values for one or more causal factors. Prediction module 262 of planning and execution system 120 predicts a volume Y (target) from a set of causal factors X along with causal factors strengths that describe the strength of each causal factor variable contributing to the predicted volume. According to some embodiments, prediction module 262 generates predictions at daily intervals. However, embodiments contemplate longer and shorter prediction phases that may be performed, for example, weekly, twice a week, twice a day, hourly, or the like.

Transaction data 270 of planning and execution system 120 database 124 may comprise recorded sales and returns transactions and related data, including, for example, a transaction identification, time and date stamp, channel identification (such as stores or online touchpoints), product identification, actual cost, selling price, sales volume, customer identification, promotions, and/or the like. In addition, transaction data 270 is represented by any suitable combination of values and dimensions, aggregated or un-aggregated, such as, for example, sales per week, sales per week per location, sales per day, sales per day per season, or the like.

Supply chain data 272 may comprise any data of one or more supply chain entities 150 including, for example, item data, identifiers, metadata (comprising dimensions, hierarchies, levels, members, attributes, cluster information, and member attribute values), fact data (comprising measure values for combinations of members), business constraints, goals, and objectives of one or more supply chain entities 150.

Product data 274 of database 124 may comprise products identified by, for example, a product identifier (such as a Stock Keeping Unit (SKU), Universal Product Code (UPC) or the like), and one or more attributes and attribute types associated with the product ID. Product data 274 may comprise data about one or more products organized and sortable by, for example, product attributes, attribute values, product identification, sales volume, demand forecast, or any stored category or dimension. Attributes of one or more products may be, for example, any categorical characteristic or quality of a product, and an attribute value may be a specific value or identity for the one or more products according to the categorical characteristic or quality, including, for example, physical parameters (such as, for example, size, weight, dimensions, color, and the like).

Inventory data 276 of database 124 may comprise any data relating to current or projected inventory quantities or states, order rules, or the like. For example, inventory data 276 may comprise the current level of inventory for each item at one or more stocking points across supply chain network 100. In addition, inventory data 276 may comprise order rules that describe one or more rules or limits on setting an inventory policy, including, but not limited to, a minimum order volume, a maximum order volume, a discount, and a step-size order volume, and batch quantity rules. According to some embodiments, planning and execution system 120 accesses and stores inventory data 276 in database 124, which may be used by planning and execution system 120 to place orders, set inventory levels at one or more stocking points, initiate manufacturing of one or more components, or the like in response to, and based at least in part on, a forecasted demand of planning and execution system 120.

Inventory policies 278 of database 124 may comprise any suitable inventory policy describing the reorder point and target quantity, or other inventory policy parameters that set rules for planning and execution system 120 to manage and reorder inventory. Inventory policies 278 may be based on target service level, demand, cost, fill rate, or the like. According to embodiments, inventory policies 278 comprise target service levels that ensure that a service level of one or more supply chain entities 150 is met with a set probability. For example, one or more supply chain entities 150 may set a service level at 95%, meaning one or more supply chain entities 150 sets the desired inventory stock level at a level that meets demand 95% of the time. Although a particular service level target and percentage is described, embodiments contemplate any service target or level, such as, for example, a service level of approximately 99% through 90%, a 75% service level, or any suitable service level, according to particular needs. Other types of service levels associated with inventory quantity or order quantity may comprise, but are not limited to, a maximum expected backlog and a fulfillment level. Once the service level is set, planning and execution system 120 may determine a replenishment order according to one or more replenishment rules, which, among other things, indicates to one or more supply chain entities 150 to determine or receive inventory to replace the depleted inventory. By way of example only and not by way of limitation, an inventory policy for non-perishable goods with linear holding and shorting costs comprises a min./max. (s,S) inventory policy. Other inventory policies 278 may be used for perishable goods, such as fruit, vegetables, dairy, fresh meat, as well as electronics, fashion, and similar items for which demand drops significantly after a next generation of electronic devices or a new season of fashion is released.

Store data 280 may comprise data describing the stores of one or more retailers and related store information. Store data 280 may comprise, for example, a store ID, store description, store location details, store location climate, store type, store opening date, lifestyle, store area (expressed in, for example, square feet, square meters, or other suitable measurement), latitude, longitude, and other similar data.

Customer data 282 may comprise customer identity information, including, for example, customer relationship management data, loyalty programs, and mappings between product purchases and one or more customers so that a customer associated with a transaction may be identified. Customer data 282 may comprise data relating customer purchases to one or more products, geographical regions, store locations, or other types of dimensions. In an embodiment, customer data 282 may also comprise customer profile information including demographic information and preferences.

Demand forecasts 284 of database 124 may indicate future expected demand based on, for example, any data relating to past sales, past demand, purchase data, promotions, events, or the like of one or more supply chain entities 150. Demand forecasts 284 may cover a time interval such as, for example, by the minute, hour, daily, weekly, monthly, quarterly, yearly, or any other suitable time interval, including substantially in real time. Demand may be modeled as a negative binomial or Poisson-Gamma distribution. According to other embodiments, the model also considers shelf-life of perishable goods (which may range from days (e.g., fresh fish or meat) to weeks (e.g., butter), or even months before any unsold items have to be written off as waste) as well as influences from promotions, price changes, rebates, coupons, and even cannibalization effects within an assortment range. In addition, customer behavior is not uniform but varies throughout the week and is influenced by seasonal effects and the local weather, as well as many other contributing factors. Accordingly, even when demand generally follows a Poisson-Gamma model, the exact values of the parameters of the model may be specific to a single product to be sold on a specific day in a specific location or sales channel and may depend on a wide range of frequently changing influencing causal factors. As an example only and not by way of limitation, an exemplary supermarket may stock twenty thousand items at one thousand locations. When each location of this exemplary supermarket is open every day of the year, planning and execution system 120 comprising a demand planner needs to calculate approximately 2×10\hat{ }10 demand forecasts 284 each day to derive the optimal order volume for the next delivery cycle (e.g., three days).

Supply chain models 286 of database 124 comprise characteristics of a supply chain setup to deliver the customer expectations of a particular customer business model. These characteristics may comprise differentiating factors, such as, for example, MTO (Make-to-Order), ETO (Engineer-to-Order), or MTS (Make-to-Stock). However, supply chain models 286 may also comprise characteristics that specify the supply chain structure in even more detail, including, for example, specifying the type of collaboration with the customer (e.g., Vendor-Managed Inventory (VMI)), from where products may be sourced, and how products may be allocated, shipped, or paid for, by particular customers. Each of these characteristics may lead to a different supply chain model. Prediction models 288 comprise one or more of the trained models used by planning and execution system 120 for predicting, among other variables, pricing, targeting, or retail volume, such as, for example, a forecasted demand volume for one or more products at one or more stores of one or more retailers based on the prices of the one or more products.

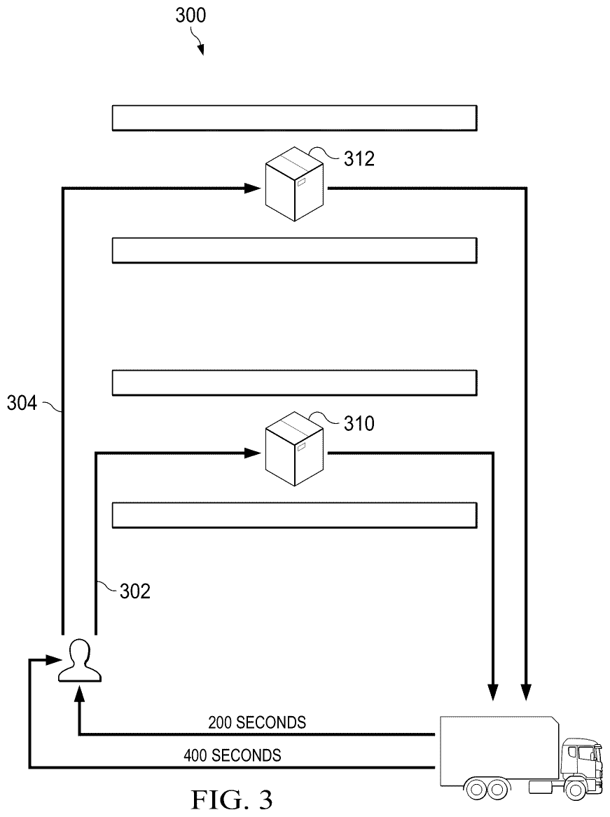

FIG. 3 illustrates diagram 300 of variations in task times in a warehouse, in accordance with an embodiment. Predicting task times in complex settings, such as a warehouse, is difficult because of the number of factors affecting the actual completion time. In the example illustrated by FIG. 3, two different pick tasks (Task A 302 and Task B 304), performed by the same worker, picking the same product, starting in the same location, and ending at the same location (loading onto a truck) may have variant times based on the location of the product to be picked. In this example, when the product to be picked is on aisle 310 illustrated by Task A 302, the task may take two hundred seconds to complete, while when the product to be picked is on aisle 312 illustrated by Task B 304, the task may take four hundred seconds to complete. While this simplified example illustrates five task attributes (resource used, source location, destination location, product picked, and product location), in real-world examples there may be many more task attributes contributing to the actual completion time of a task.

Because of this volatility in even similar tasks, using a single task time to estimate the completion time of different tasks may lead to significant errors in estimation. For example, a simple task time estimation averaging the two times is three hundred seconds, but using this simple task time estimate may quickly add up to significant errors when picks from aisle 310 are far more common than picks from aisle 312, or vice versa. A more accurate method of estimating task times individually, including all relevant factors of a scheduled task, is described in further detail herein.

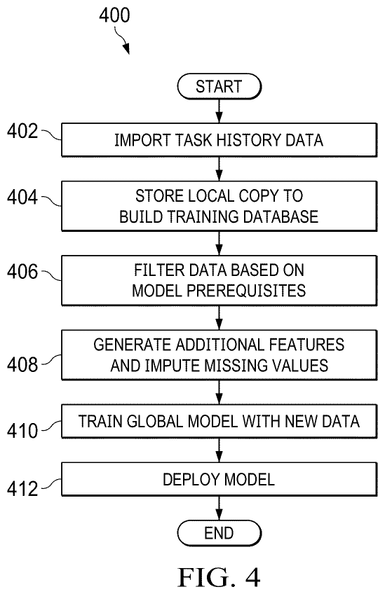

FIG. 4 illustrates method 400 for training a machine learning model to predict task times, in accordance with an embodiment. Method 400 may be performed by a task time forecasting system, such as task time forecasting system 110 of FIG. 1. Method 400 proceeds by one or more activities, which although described in a particular order, may be performed in one or more permutations, according to particular needs. According to embodiments, method 400 may be performed based on an error metric threshold, as disclosed above.

At activity 402, data cleaning module 202 of task time forecasting system 110 imports task history data 220. In the example of a warehouse, task history data 220 may be received from a warehouse management system that tracks and records all data related to tasks performed in the warehouse. For example, the warehouse management system may track start and end times for tasks, start and end locations for tasks, equipment used to perform tasks, and various other data related to the performance of tasks. In embodiments, data cleaning module 202 may receive task history data 220 in real time as tasks are completed from the warehouse management system. At activity 404, data cleaning module 202 stores a local copy of received task history data 220 to build a training database. In embodiments, task history data 220 comprises the actual time taken to complete each task, as well as other relevant task data, as disclosed above.

At activity 406, data cleaning module 202 filters and cleans task history data 220 based on model prerequisites to produce training data 222. As discussed in further detail above, data cleaning module 202 may perform various data transformations and filtering processes to, for example, remove outliers in the data or correct task time durations for task entries for which data is missing or where a data collection error has occurred, among other data errors. By way of example only and not by way of limitation, model prerequisites may include requiring data to be from warehouses that have opted to use task time forecasting system 110, requiring historically recorded tasks to have a recorded duration of less than 3.5 times the manual goal time, requiring data to be from tasks carried out by human beings, requiring data to be from warehouses that have recorded at least two months of task data, and the like. At activity 408, data cleaning module 202 may impute values that are missing from task history data 220. For example, when the number of units in a task for a particular task type is missing for a particular warehouse, data cleaning module 202 may determine an average number of units for the particular task type at the particular warehouse with similar source and/or destination locations based on task history data 220. In embodiments, the missing data may be added automatically by data cleaning module 202 or may be added manually via, for example, input into user interface module 210.

At activity 410, training module 204 of task time forecasting system 110 trains one or more machine learning models using training data 222 produced at activities 406-408. Training module 204 may use prominent features in training data 222 that influence the task time durations to train the one or more machine learning models. As disclosed above, the one or more machine learning models may comprise a decision tree model such as a random forest model. In embodiments, training module 204 may use only a portion of training data 222 that has been cleaned and filtered at activities 406-408 to retain a portion of training data 222 for use as validation data.

At activity 412, training module 204 deploys the one or more machine learning models trained at activity 410 as the current model to be used for predicting task time durations. According to embodiments, training module 204 stores previous machine learning models in machine learning model directory 224, which may enable easy debugging and access to the previous machine learning models. When task time forecasting system 110 is currently generating predictions while a new model is training using method 400, task time forecasting system 110 may use a previous model, as disclosed above.

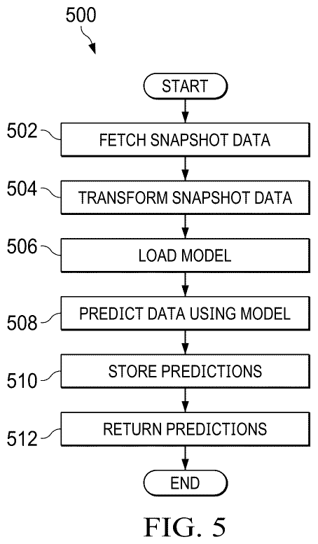

FIG. 5 illustrates method 500 for predicting task times using a machine learning model, in accordance with an embodiment. Method 500 may be performed by a task time forecasting system, such as task time forecasting system 110 of FIG. 1. Method 500 proceeds by one or more activities, which although described in a particular order, may be performed in one or more permutations, according to particular needs. In embodiments, method 500 may be performed whenever a warehouse management system or a warehouse execution system produces an updated list of scheduled tasks, referred to here as a “snapshot”, which may occur every five minutes or on any other time schedule, according to particular needs.

At activity 502, task time prediction module 206 of task time forecasting system 110 fetches snapshot data 226. In the example of a warehouse, snapshot data 226 may be received from a warehouse execution system that schedules and tracks the completion of tasks within the warehouse. For example, the warehouse execution system may produce an updated list of scheduled tasks periodically throughout the day to account for unforeseen changes in previously generated task schedules, such as tasks finishing early or late, or accidents on the warehouse floor temporarily postponing all activity. At activity 504, data cleaning module 202 of task time forecasting system 110 transforms received snapshot data 226. In embodiments, data cleaning module 202 normalizes, aggregates, and/or rescales snapshot data 226 to allow direct comparison to task history data 220 that has been used to train one or more machine learning modules, as illustrated by method 400 of FIG. 4.

At activity 506, task time prediction module 206 loads a previously saved machine learning model (such as a machine learning model trained according to method 400 of FIG. 4) and, at activity 508, uses the saved machine learning model to predict goal time values corresponding to snapshot data 226. Using the trained machine learning model, task time prediction module 206 predicts goal time values that are tailored to individual tasks of individual locations, resulting in significantly more accurate goal time values than in existing systems, which set goal times solely based on the task type. At activity 510, task time prediction module 206 stores the predicted goal time values as goal time data 230 of database 114. In embodiments, error metric module 208 may use the stored predicted goal time values to calculate error metrics, as described in greater detail below. At activity 512, task time prediction module 206 returns the predicted goal time values. In the example of a warehouse, task time prediction module 206 returns the predicted goal time values to the warehouse execution system where snapshot data 226 is fetched from at activity 502.

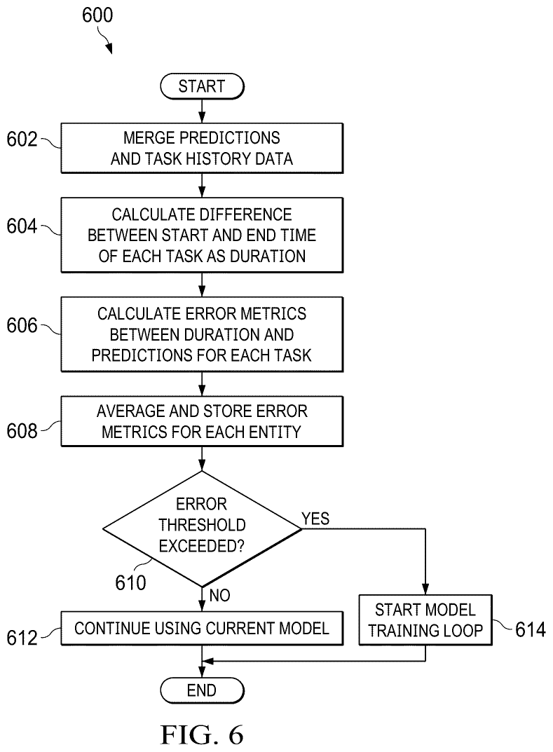

FIG. 6 illustrates method 600 for determining machine learning model retraining, in accordance with an embodiment. Method 600 may be performed by a task time forecasting system, such as task time forecasting system 110 of FIG. 1. Method 600 proceeds by one or more activities, which although described in a particular order, may be performed in one or more permutations, according to particular needs. In embodiments, method 600 may be performed whenever a warehouse execution system produces an updated list of completed tasks, which may occur in real time as received by the warehouse execution system or on a time schedule such as, for example, every five minutes.

At activity 602, data cleaning module 202 of task time forecasting system 110 merges predicted task time durations (goal time data 230) and task history data 220. According to embodiments, data cleaning module 202 may filter and clean task history data 220 to enable direct comparison between task history data 220 and goal time data 230. At activity 604, error metric module 208 of task time forecasting system 110 calculates the difference between the start time and the end time of each completed task. This calculation results in the actual time taken, or duration, to complete each task.

At activity 606, error metric module 208 calculates one or more error metrics between the duration calculated at activity 604 and the predicted task time durations of goal time data 230 for each task. The one or more error metrics may include, for example, MAE, RMSE, and MAPE, among others. In embodiments, error metric module 208 may use multiple error metrics for each task. At activity 608, error metric module 208 averages the error metric values for each supply chain entity of one or more supply chain entities 150 using task time forecasting system 110 over a period of time and stores the averaged error metric values as error metric data 228. For example, error metric module 208 may average the calculated error metric values over a period of one hour, one day, one week, or any other time period according to particular needs.

At activity 610, error metric module 208 determines whether the averaged error metric values calculated at activity 608 exceeds a threshold. According to embodiments, the threshold may be based on user input via user interface module 210. When error metric module 208 determines that the averaged error metric values calculated at activity 608 does not exceed the threshold at activity 610, error metric module 208 determines to continue using the current machine learning model to generate goal time predictions at activity 612. When error metric module 208 determines that the averaged error metric values calculated at activity 608 does exceed the threshold at activity 610, error metric module 208 determines that the machine learning model is to be retrained via a model training loop (such as, for example, method 400 of FIG. 4) at activity 614.

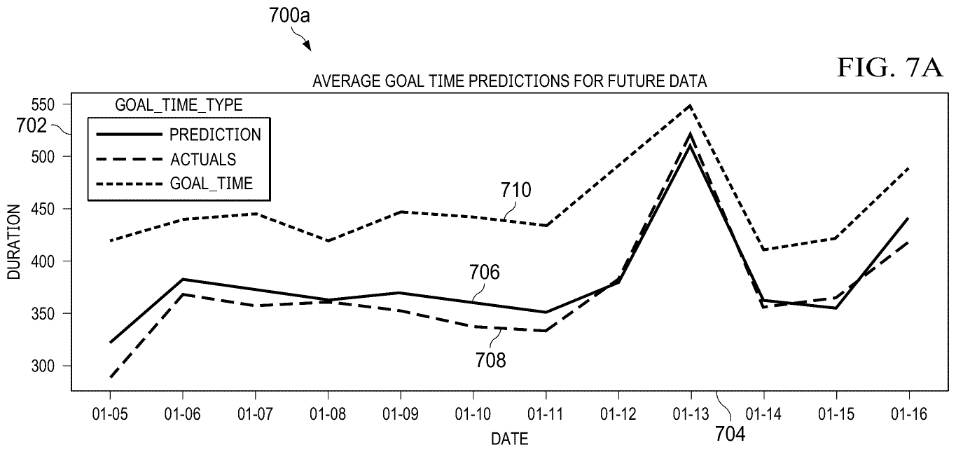

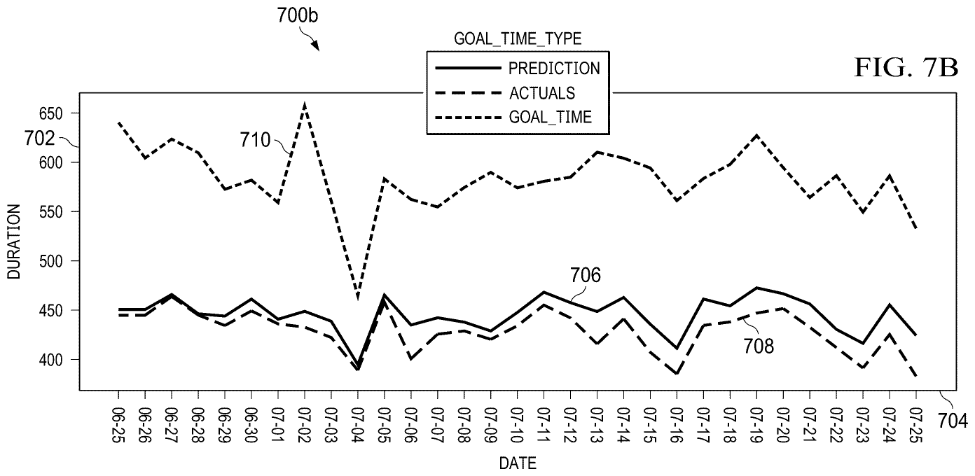

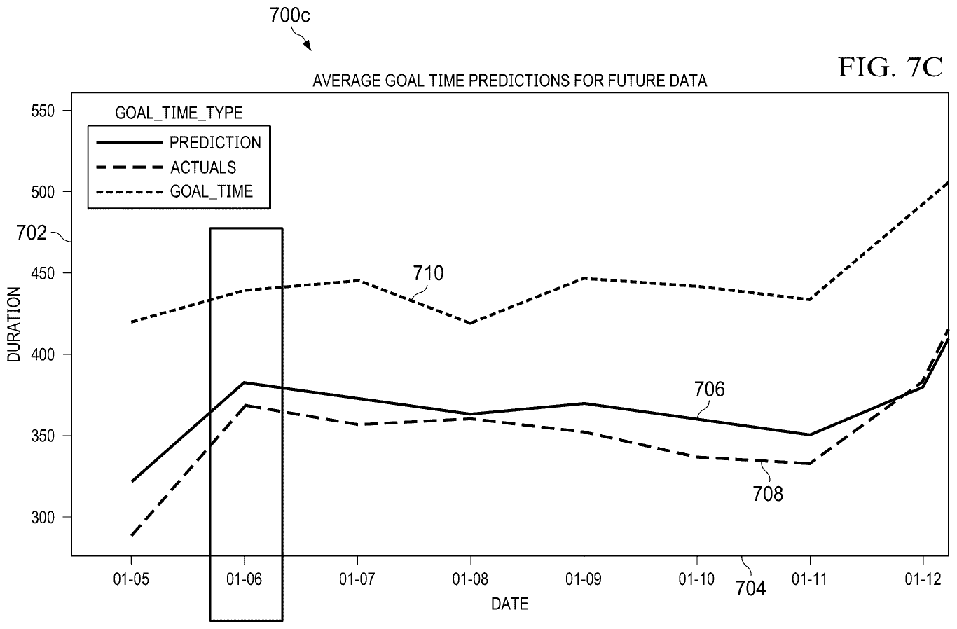

FIGS. 7A-7C illustrate predicted goal time graphs 700a-700c, in accordance with an embodiment. Predicted goal time graphs 700a-700c illustrate predicted goal times (task completion times) in seconds along Y-axis 702 for different dates along X-axis 704. Predicted goal time graphs 700a-700c chart ML goal time (prediction) 706, or ML goal times generated according to method 500 described in FIG. 5, duration (actuals) 708, or the actual completion time of the tasks, and static goal time 710 (goal_time), or the goal times set via an existing task time prediction method. The predicted ML goal times of predicted goal time graphs 700a-700c have been generated according to historical data to compare the performance against actual task durations.

Predicted goal time graph 700a illustrates task times predicted over a twelve-day period, January 5th through January 16th, predicted goal time graph 700b illustrates task times predicted over a thirty-one-day period, June 25th through July 25th, and predicted goal time graph 700c illustrates time predicted over an eight-day period, January 5th through January 12th. As shown in predicted goal time graphs 700a-700c, ML goal time 706 more accurately predicts goal times closer to the actual durations of the tasks, duration 708, compared to static goal time 710. In some instances, static goal time 710 may significantly vary from duration 708. For example, on July 2nd as illustrated in predicted goal time graph 700b, static goal time 710 is over two hundred seconds longer than duration 708, while ML goal time 706 is significantly more accurate.

TABLE 1
Cost Breakdown of ML Goal Time

| Number of Employees | 116 | Workers |
|---|---|---|
| Total Tasks Carried out | 1850 | Tasks |
| Base Salary | $18/Hour | |
| Overtime Salary | $27/Hour | |
| Unaccounted Goal Time | 37 | Hours |
| Unaccounted ML Goal Time | 8 | Hours |
| Unaccounted Time | 29 | Hours |

| | |
|---|---|
| Average Unaccounted Time | 15.6 Mins/Worker |
| Daily Savings (Base) | $542.88/Day |
| Daily Savings (Overtime) | $814/Day |
| Yearly Savings (Base) | $198,151.20/Year |
| Yearly Savings (Overtime) | $297,226.80/Year |

TABLE 1 shows an estimated financial impact of using ML goal time, according to an embodiment. TABLE 1 illustrates a financial impact based on January 6th as highlighted in predicted goal time graph 700c of FIG. 7C. According to the example of TABLE 1, there are one hundred sixteen employees in the warehouse, carrying out 1,850 tasks total on January 6th. When the base salary of these employees (on average) is $18 per hour and the overtime salary of those employees (on average) is $27 an hour, the financial impact of ML goal time may be estimated by determining the amount of time saved because of ML goal time-based warehouse planning.

In the example of FIG. 7C, on January 6th, static goal time 710 estimated, on average, a completion time of roughly four hundred forty seconds, while ML goal time 706 estimated, on average, a completion time of roughly three hundred eighty seconds. This difference in seconds, across all tasks, adds up to twenty-nine hours of “unaccounted time” meaning time where employees did not work on any tasks, as scheduled tasks were already completed, because of the over-estimation of completion time by static goal time 710. These twenty-nine hours of unaccounted time averaged across all one hundred sixteen employees is roughly 15.6 minutes per employee. Using the average salaries discussed above, these twenty hours of unaccounted time add up to $542.88 per day, when using base salary, in unused employee time on January 6th alone, or $814 per day when using overtime salary.

Warehouse planning or scheduling using ML goal time may avoid these twenty-nine hours of unaccounted time due to more accurate task time predictions. Over the course of a year, these daily savings of $542.88 to $814 may add up to $198, 151.20 to $297,226.80 in savings for the warehouse. Thus, the use of ML goal time as discussed herein may lead to significant financial savings for warehouse operators by improving schedule efficiency.

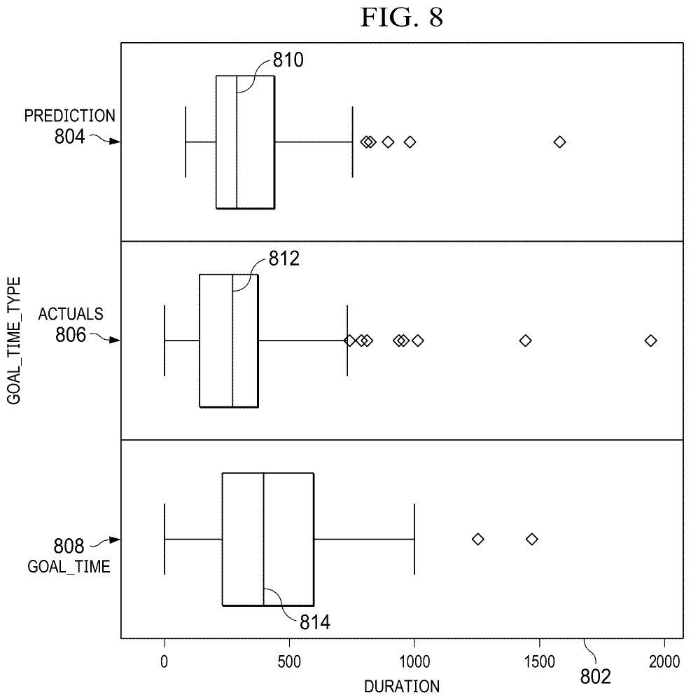

FIG. 8 illustrates box plots 804-808 for task time prediction methods, in accordance with an embodiment. Prediction box plot 804 refers to ML goal time, or task time predictions generated by the systems and methods disclosed herein. Actuals box plot 806 refers to actual task completion times, and goal_time box plot 808 refers to task time predictions generated by existing task time prediction methods.

Prediction box plot 804, showing ML goal time, follows similar minimums and maximums as actuals box plot 806, showing actual duration. Further, median 810 of prediction box plot 804, shown as the line internal to prediction box plot 804, is close to median 812 of actuals box plot 806. Goal_time box plot 808, showing static goal time, shows a drastically different maximum and minimum compared to duration box plot 806, and median 814 of goal_time box plot 808 is significantly further from median 812 of actuals box plot 806 than median 810 of prediction box plot 804, demonstrating the error in using static goal time to predict actual durations.

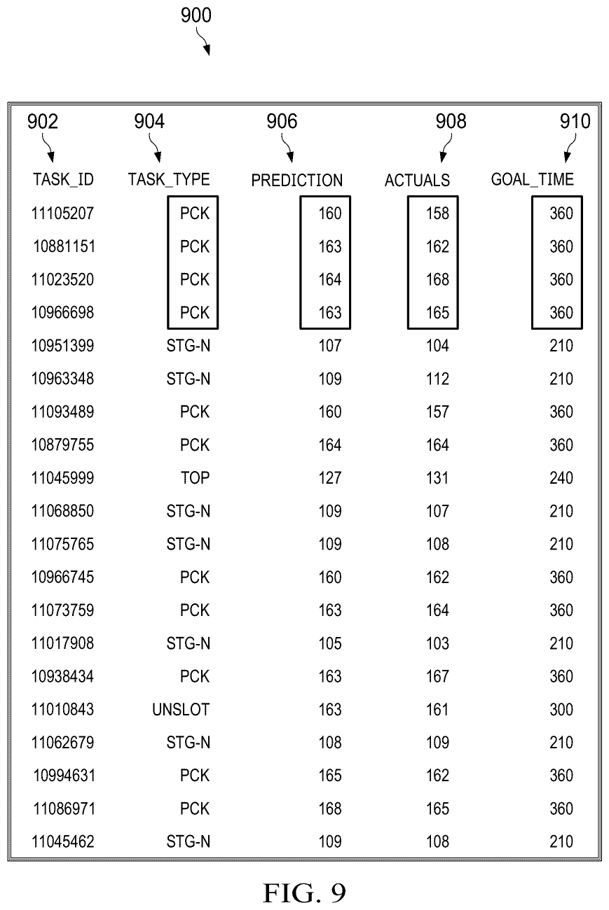

FIG. 9 illustrates output 900 of a task time forecasting system, such as task time forecasting system 110 of FIG. 1, in accordance with an embodiment. Output 900 may be generated by user interface module 210 of task time forecasting system 110 and displayed on an output device within supply chain network 100, as described in greater detail above.

Output 900 shows a task list of tasks identified by task ID (task_id) 902, including task type (task_type) 904, ML goal time (prediction) 906, actual duration (actuals) 908, and static goal time (goal_time) 910 for each task. In this example, four tasks of task type 904 “PCK,” or picks, are highlighted. In other examples, task type 904 may include transfer, storage, replenishment, layer pick, list pick, case pick, and the like. Static goal time 910 for these four tasks is three hundred sixty seconds each for a total of 1,440 seconds, because static goal time 910 is based only on task type 904. ML goal time 906 for these four tasks is one hundred sixty seconds, one hundred sixty-three seconds, one hundred sixty-four seconds, and one hundred sixty-three seconds, respectively, adding up to a total of six hundred fifty seconds, which varies significantly from static goal time 910 because ML goal time 906 is based on other features of the tasks.

The actual duration, actuals 908, for the four highlighted tasks is one hundred fifty-eight seconds, one hundred sixty-two seconds, one hundred sixty-eight seconds, and one hundred sixty-five seconds, respectively, adding up to a total of six hundred fifty-three seconds. Thus, in this example, the use of ML goal time decreases the planning error from seven hundred eighty-seven seconds (the difference between the total prediction of 1,440 seconds of static goal time 910 and actual duration 908 of six hundred fifty-three seconds) to only three seconds (the difference between the total prediction of six hundred fifty seconds of ML goal time 906 and actual duration 908 of six hundred fifty-three seconds). This improvement in planning error of approximately thirteen minutes across only four tasks demonstrates the accuracy of using ML goal times compared to static goal times used by existing task time prediction methods.

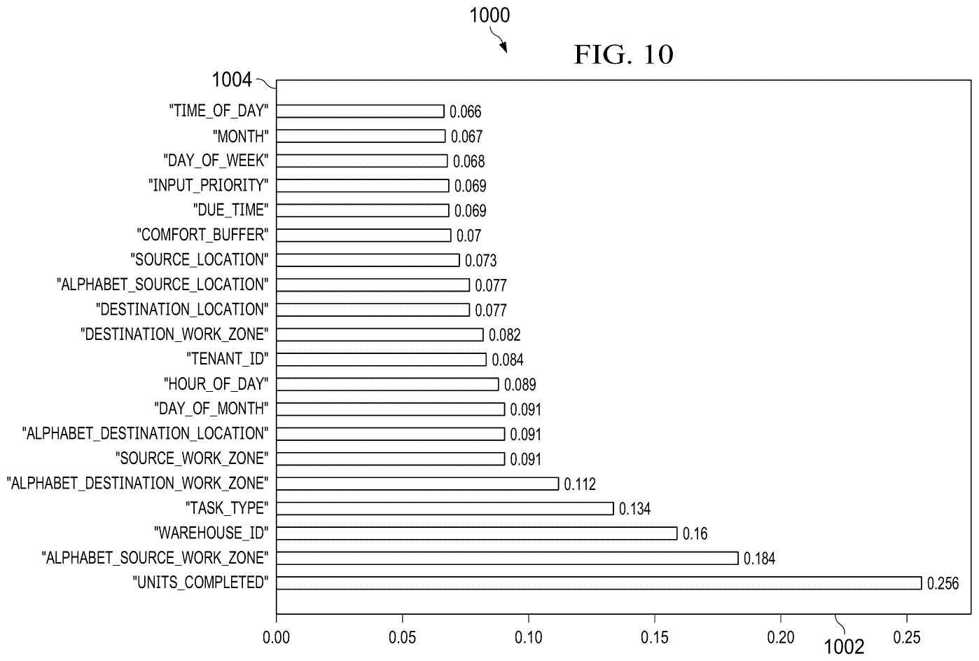

FIG. 10 illustrates feature impact graph 1000, in accordance with an embodiment. Feature impact graph 1000 may be generated by user interface module 210 of task time forecasting system 110 and displayed on an output device within supply chain network 100, as described in greater detail above. Feature impact graph 1000 indicates which values contribute most to changes in predicted times for ML goal times compared to static goal times. Feature impact graph 1000 shows impact on X-axis 1002 corresponding to various features on Y-axis 1004.

In embodiments, the one or more machine learning models may be trained using the features charted on Y-axis 1004 of feature impact graph 1000. In this example, using data from a single warehouse, the most important features used in training the one or more machine learning models are units-completed (the number of subtasks within a task), alphabet_source_work zone (where the task originates), warehouse_ID (the warehouse that the task takes place in), and task_type (the category of task to complete).

Reference in the foregoing specification to “one embodiment”, “an embodiment”, or “some embodiments” means that a particular correlated factor, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A system for determining machine learning model retraining, comprising:
a computer, comprising a processor and a memory, the computer configured to:
merge predicted task time durations and task history data, wherein the predicted task time durations are based on a machine learning model;
calculate a difference between a start time and an end time for each of one or more completed tasks to calculate a duration for each of the one or more completed tasks;
calculate one or more error metrics based, at least in part, on the duration of each of the one or more completed tasks and a corresponding predicted task time duration for each of the one or more completed tasks;
average the one or more error metrics over a period of time and store the averaged one or more error metrics as error metric data;
determine whether the averaged one or more error metrics exceed a threshold;
in response to determining that the threshold has not been exceeded, continue use of the machine learning model to predict task time durations; and
in response to determining that the threshold has been exceeded, retrain the machine learning model via a model training loop.

2. The system of claim 1, wherein the computer is further configured to:
filter and clean the task history data to enable a direct comparison between the task history data and goal time data.

3. The system of claim 1, wherein the one or more error metrics comprise one or more of: one or more root mean square error calculations, one or more mean absolute percentage error calculations and one or more mean absolute error calculations.

4. The system of claim 1, wherein the model training loop is based, at least in part, on task history data received in real time from a warehouse management system.

5. The system of claim 1, wherein the predicted task time durations are tailored to one or more individual tasks of one or more individual locations.

6. The system of claim 1, wherein the machine learning model comprises a decision tree.

7. The system of claim 1, wherein the computer is further configured to:
store previous machine learning models in a machine learning model directory.

8. A computer-implemented method for determining machine learning model retraining, comprising:
merging, by a computer comprising a processor and a memory, predicted task time durations and task history data, wherein the predicted task time durations are based on a machine learning model;
calculating, by the computer, a difference between a start time and an end time for each of one or more completed tasks to calculate a duration for each of the one or more completed tasks;
calculating, by the computer, one or more error metrics based, at least in part, on the duration of each of the one or more completed tasks and a corresponding predicted task time duration for each of the one or more completed tasks;
averaging, by the computer, the one or more error metrics over a period of time and storing, by the computer, the averaged one or more error metrics as error metric data;
determining, by the computer, whether the averaged one or more error metrics exceed a threshold;
in response to determining that the threshold has not been exceeded, continuing, by the computer, use of the machine learning model to predict task time durations; and
in response to determining that the threshold has been exceeded, retraining, by the computer, the machine learning model via a model training loop.

9. The computer-implemented method of claim 8, further comprising:
filtering and cleaning, by the computer, the task history data to enable a direct comparison between the task history data and goal time data.

10. The computer-implemented method of claim 8, wherein the one or more error metrics comprise one or more of: one or more root mean square error calculations, one or more mean absolute percentage error calculations and one or more mean absolute error calculations.

11. The computer-implemented method of claim 8, wherein the model training loop is based, at least in part, on task history data received in real time from a warehouse management system.

12. The computer-implemented method of claim 8, wherein the predicted task time durations are tailored to one or more individual tasks of one or more individual locations.

13. The computer-implemented method of claim 8, wherein the machine learning model comprises a decision tree.

14. The computer-implemented method of claim 8, further comprising:
storing, by the computer, previous machine learning models in a machine learning model directory.

15. A non-transitory computer-readable medium embodied with software for determining machine learning model retraining, the software when executed is configured to:
merge, by a computer comprising a processor and a memory, predicted task time durations and task history data, wherein the predicted task time durations are based on a machine learning model;
calculate a difference between a start time and an end time for each of one or more completed tasks to calculate a duration for each of the one or more completed tasks;
calculate one or more error metrics based, at least in part, on the duration of each of the one or more completed tasks and a corresponding predicted task time duration for each of the one or more completed tasks;
average the one or more error metrics over a period of time and store the averaged one or more error metrics as error metric data;
determine whether the averaged one or more error metrics exceed a threshold;
in response to determining that the threshold has not been exceeded, continue use of the machine learning model to predict task time durations; and
in response to determining that the threshold has been exceeded, retrain the machine learning model via a model training loop.

16. The non-transitory computer-readable medium of claim 15, wherein the software when executed is further configured to:
filter and clean the task history data to enable a direct comparison between the task history data and goal time data.

17. The non-transitory computer-readable medium of claim 15, wherein the one or more error metrics comprise one or more of: one or more root mean square error calculations, one or more mean absolute percentage error calculations and one or more mean absolute error calculations.

18. The non-transitory computer-readable medium of claim 15, wherein the model training loop is based, at least in part, on task history data received in real time from a warehouse management system.

19. The non-transitory computer-readable medium of claim 15, wherein the predicted task time durations are tailored to one or more individual tasks of one or more individual locations.

20. The non-transitory computer-readable medium of claim 15, wherein the machine learning model comprises a decision tree.
